(19) United States
(12) Patent Application Publication
(10) Pub. No.: US 2024/0049185 A1
(43) Pub. Date: Feb. 8, 2024

(54) METHOD AND APPARATUS FOR PROVIDING OPTIMAL COMMUNICATION FOR MULTIPLE USER TERMINALS

(71) Applicant: KT CORPORATION, Gyeonggi-do (KR)

(72) Inventors: Sehoon YANG, Gyeonggi-do (KR); Seyoung PARK, Gyeonggi-do (KR)

(73) Assignee: KT CORPORATION, Gyeonggi-do (KR)

(21) Appl. No.: 18/351,073

(22) Filed: Jul. 12, 2023

(30) Foreign Application Priority Data
Aug. 2, 2022 (KR) 10-2022-0096221

(51) Int. Cl. H04W 72/04; H04W 72/52; H04W 72/541

(52) U.S. Cl. CPC H04W 72/04; H04W 72/52; H04W 72/541

(57) ABSTRACT

According to an exemplary embodiment of the disclosure, an optimal communication providing method performed by a computing device includes obtaining terminal attribute information for each of a plurality of user terminals accessible to a single AP, calculating a channel score for each channel within each band provided by the single AP, based on a pre-constructed radio map for the single AP and at least some of pieces of the terminal attribute information of the plurality of user terminals, and determining an optimal channel for the plurality of user terminals for each band provided by the single AP, based on the channel score.

### CROSS-REFERENCE TO RELATED APPLICATION

This application claims priority to and the benefit of Korean Patent Application No. 10-2022-0096221 filed in the Korean Intellectual Property Office on Aug. 02, 2022, the entire contents of which are incorporated herein by reference.

### BACKGROUND

### (a) Field

The present disclosure relates to a method and apparatus for providing optimal communication for multiple user terminals.

### (b) Description of the Related Art

Recently, with the activation of smart terminals and media services, data usage has continuously increased. The use of Wi-Fi-based wireless communication indoors has increased thanks to the widespread of Wi-Fi technology. However, in certain environment such as apartments, studios, etc., where a Wi-Fi access point (AP) is not installed in a built-up type, such as an office, individual households often set up their own Wi-Fi APs. This environment makes it challenging to achieve integrated optimization, leading to potential performance degradation due to interference between Wi-Fi channels.

In order to minimize such a problem, one approach to minimize the problem is to optimize the default channel, which is usually set for each band (2.4 or 5 GHz) when the AP is initially installed, through user setting or automated processed. From the user's perspective, the optimization may appear to improve the uplink signal. However, services mainly used by users, such as video streaming, gaming, and file transmission, may often generate downlink traffic. As a result, the channel selected in the AP setting stage may not be considered as an optimal channel for these types of activities.

In addition, since the number of terminals that may access an AP is not limited to a single terminal in a general communication environment, such as homes, it is common for several terminals to access a single AP at the same time, and in this case, the performance (e.g., a transfer rate) required for each terminal is different. However, in the case of a general AP, it is impossible to utilize multiple channels separated within a single band.

Therefore, there is demand in the art for a technology capable of improving user satisfaction with communication quality by dynamically determining optimal communication that a single AP may provide by comprehensively considering the attributes of each of several accessible terminals.

### SUMMARY

The present disclosure is to dynamically determine and provide the optimal communication that may be provided by a single AP by comprehensively considering the attributes of each of several accessible terminals through a pre-constructed radio map. In addition to the above tasks, the present disclosure may be used to achieve other tasks not specifically mentioned.

According to some exemplary embodiments of the disclosure, an optimal communication providing method performed by a computing device includes: obtaining terminal attribute information for each of a plurality of user terminals accessible to a single AP; calculating a channel score for each channel within each band provided by the single AP, based on a pre-constructed radio map for the single AP and at least some of pieces of the terminal attribute information of the plurality of user terminals; and determining an optimal channel for the plurality of user terminals for each band provided by the single AP, based on the channel score.

The terminal property information may include at least some of an accessible band of each of the plurality of user terminals, whether each of the plurality of user terminals is movable, and an induced amount of traffic.

The induced amount of traffic may be obtained in the form of a ratio based on a user terminal with the largest induced amount of traffic for each preset time period.

The calculating of the channel score may include: obtaining, for each of the user terminals whose accessible bands correspond to each other, a SINR value for a first channel within the corresponding accessible band, based on the radio map; calculating a channel score of each user terminal for the first channel based on at least some of the SINR value of each of the user terminals whose accessible bands correspond to each other and the induced amount of traffic; and calculating the channel score of the first channel by integrating the channel scores of the respective user terminals.

The SINR value may be a value dependent on a real-time location of each of the user terminals.

The calculating of the channel score may further include: pre-filtering channels having an SINR value less than a predetermined threshold, among channels within the accessible band, so that the channel score is not calculated.

The determining of the optimal channel may include: determining a channel having the highest channel score, among channels in the band, as the optimal channel for each band provided by the single AP.

The plurality of user terminals may include at least one band-fixed terminals for which a single access band is determined, and at least one band-changeable terminal for which an access band is changeable.

The determining of the optimal channel may include: calculating a primary channel score for each of the channels in the corresponding access band for the band-fixed terminals, among the user terminals whose access bands correspond to each other; calculating the channel score for each of the channels within the corresponding access band by reflecting the terminal attribute information on the band changeable terminals on the calculated primary channel score; and determining a band and the optimal channel to be accessed by the band-changeable terminal based on the calculated channel score.

The radio map may be pre-constructed based on propagation information including reception sensitivity level information for each location of the single AP and interference information for each channel in the band for the single AP.

According to some exemplary embodiments of the disclosure, an optimal communication providing method performed by a computing device includes: obtaining terminal attribute information for each of a plurality of user terminals accessible to a single AP; calculating a primary channel score for each of channels within an access band, based on the terminal attribute information for at least one band-fixed terminal for which a single access band is determined, among a plurality of user terminals; and determining an optimal channel for the plurality of user terminals for each band provided by the single AP, based on a channel score calculated by reflecting the terminal attribute information on band-changeable terminals for which an access band is changeable, among the plurality of user terminals, on the primary channel score.

The terminal attribute information may include at least some of an accessible band of each of the plurality of user terminals, whether each of the plurality of user terminals is movable, and an induced amount of traffic.

The induced amount of traffic may be obtained in the form of a ratio based on a user terminal with the largest induced amount of traffic for each preset time period.

The calculating of the primary channel score may include: obtaining, for each of the user terminals whose accessible bands correspond to each other, a SINR value for a first channel within the corresponding access band, based on a pre-constructed radio map; calculating a channel score of each user terminal for the first channel, based on at least some of the SINR value of each of the user terminals whose access bands correspond to each other and the induced amount of traffic, and calculating the primary channel score of the first channel by integrating the channel scores of the respective user terminals.

The SINR value may be a value dependent on a real-time location of each of the user terminals.

The calculating of the primary channel score may further include: pre-filtering channels having an SINR value less than a predetermined threshold, among channels within the access band, so that the primary channel score is not calculated.

The determining of the optimal channel may include: determining, for each band provided by the single AP, a channel having the highest channel score, among channels in the band, as the optimal channel.

According to some exemplary embodiments of the disclosure, a computing apparatus includes a memory comprising instructions; and a processor executing the instructions to: obtain terminal attribute information for each of a plurality of user terminals accessible to a single AP; calculate a channel score for each channel within each band provided by the single AP, based on a pre-constructed radio map for the single AP and at least some of pieces of the terminal attribute information of the plurality of user terminals; and determine an optimal channel for the plurality of user terminals for each band provided by the single AP, based on the channel score.

The calculating of the channel score may include: obtaining, for each of the user terminals whose accessible bands correspond to each other, a SINR value for a first channel within the corresponding accessible band, based on the radio map; calculating a channel score of each user terminal for the first channel based on at least some of the SINR value of each of the user terminals whose accessible bands correspond to each other and the induced amount of traffic; and calculating the channel score of the first channel by integrating the channel scores of the respective user terminals.

The radio map may be pre-constructed based on propagation information including reception sensitivity level information for each location of the single AP and interference information for each channel in the band for the single AP.

According to some exemplary embodiments of the present disclosure, quality of service (QoS) may be improved by providing a communication service through an optimal channel that comprehensively considers attributes of each of multiple terminals accessible to a single AP.

According to some exemplary embodiments of the present disclosure, it is possible to expand scalability and applicability compared to costs for construction of a radio map database (DB) by suggesting an additional utilization method of the radio map DB for providing a location-based service.

According to some exemplary embodiments of the present disclosure, it is possible to preemptively respond to customer complaints through monitoring of wire quality, as well as wireless Wi-Fi quality.

### BRIEF DESCRIPTION OF THE DRAWINGS

FIG. 1 is a block diagram illustrating an optimal communication providing apparatus according to some exemplary embodiments of the present disclosure.

FIG. 2 is a flowchart illustrating an optimal communication providing method according to some exemplary embodiments of the present disclosure.

FIG. 3 is a block diagram illustrating a computing device for providing an optimal communication providing method according to some exemplary embodiments of the present disclosure.

### DETAILED DESCRIPTION OF THE EXEMPLARY EMBODIMENTS

Hereinafter, exemplary embodiments will be described in detail with reference to the accompanying drawings such that they may be easily practiced by those skilled in the art to which the present disclosure pertains. As those skilled in the art would realize, the described exemplary embodiments may be modified in various different ways, all without departing from the spirit or scope of the present disclosure. In the accompanying drawings, a portion irrelevant to description of the present disclosure will be omitted for clarity, and like reference numerals refer to like elements throughout.

It will be further understood that the term “include” is used to specify that any one component includes the other component, this does not preclude the presence or addition of one or more other components unless otherwise stated. Devices constituting a network may be implemented as hardware, software, or a combination of hardware and software.

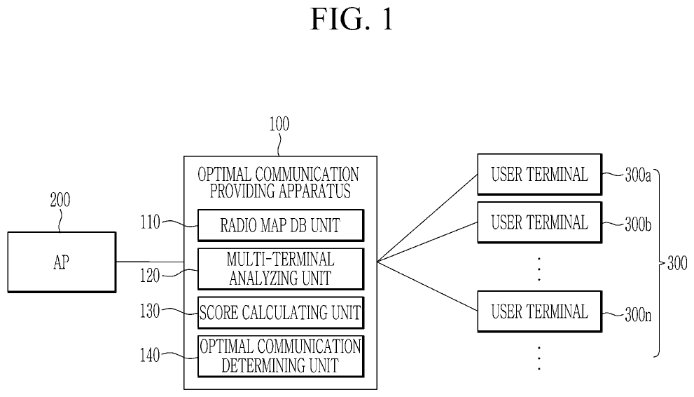

FIG. 1 is a block diagram illustrating an optimal communication providing apparatus according to some exemplary embodiments of the present disclosure.

Referring to FIG. 1, an optimal communication providing apparatus 100 according to the present disclosure may include a radio map database (DB) unit 110, a multi-terminal analyzing unit 120, a score calculating unit 130, and an optimal communication determining unit 140. However, the components described above are not essential to implement the optimal communication providing apparatus 100 according to the present disclosure, and the optimal communication providing apparatus 100 may have more or fewer components than the above-listed components.

Meanwhile, the optimal communication providing apparatus 100 may be communicatively connected to at least one access point (AP) 200 and a plurality of user terminals 300: 300a, 300b, . . . , 300n. In FIG. 1, for convenience of description, the optimal communication providing apparatus 100 is shown separately from the AP 200 and the user terminals 300, but the present disclosure is not limited to that configuration, and the optimal communication providing apparatus 100 may be implemented in the AP 200 or the user terminals 300.

The radio map DB unit 110 may be constructed by collecting propagation information associated with the AP 200. Specifically, the radio map DB unit 110 may collect and store propagation information related to the AP 200 in units of locations of one or more grids constituting a specific area. The collected propagation information may include at least some of AP identification information, such as SSID or BSSID, reception sensitivity level information of signals for each AP, channel information for each AP, interference information for each channel, and bandwidth information.

The radio map DB unit 110 may estimate a location of each of the multiple user terminals 300 to be provided with an optimal channel providing method of the present disclosure, and may be utilized to obtain a signal-to-interference noise ratio (SINR) for each channel in the estimated location. The obtained SINR value may be used to determine a channel that may provide optimal communication for multiple user terminals 300 that may access the AP 200.

Regarding the SINR value, since the multiple user terminals 300 may exist in different locations, respectively, they may have different SINR values. A difference in SINR values may be caused not only by an interference component, but also by a distance or positional relationship between the AP 200 and the user terminals 300. Therefore, the location of each of the user terminals 300 may be estimated by substituting the AP information collected from the user terminals 300 into the radio map DB unit 110, and the SINR value may be obtained by utilizing the interference component previously collected at the corresponding location.

Meanwhile, in location estimation, the reception sensitivity level for each AP collected from each of the multiple user terminals 300 may be compared with reception sensitivity level information of a signal for each AP stored in the radio map DB unit 110 in units of grid locations. A grid location having a pattern of the most similar reception sensitivity level for each AP may be estimated as a current location of each of the user terminals 300. Here, the pattern of reception sensitivity levels may include a distribution pattern of absolute values or difference values of reception sensitivity levels for each AP.

The multi-terminal analyzing unit 120 may collect and analyze attributes of each of multiple user terminals 300 accessible to the AP 200.

Specifically, the multi-terminal analyzing unit 120 may collect attribute information including an accessible band of each of the multiple user terminals 300, whether each of the multiple user terminals is movable, and an induced amount of traffic. Such attribute information may be collected from each of the multiple user terminals 300.

Regarding the accessible bands of the multiple user terminals 300, for example, high-end terminals may be able to access all of the 2.4 GHz, 5 GHz, and 6 GHz bands and may be accessible to only any one of the 2.4 GHz or 5 GHz bands according to terminals.

Regarding whether the multiple user terminals 300 are movable, each of the user terminals 300 may be classified as at least one of a mobile type, such as a smartphone, and a fixed type, such as an IoT device including a refrigerator or washing machine.

Regarding the induced amount of traffic of the multiple user terminals 300, since the induced amount of traffic of each of the multiple user terminals 300 is different according to a time period, the induced amount of traffic may be collected separately for each time period. A time period may be a specific time within a day (e.g., 3:00 to 6:00 p.m., daily work time, non-daily work time, daytime, nighttime, etc.), or a specific day of the week (e.g., weekdays, weekends, etc.). The time period may be subdivided or simplified based on a cycle in which communication optimization is to be performed according to the present disclosure.

For example, a smartphone, which is the mobile user terminal 300, may induce a lot of traffic on average, but there may be no induced amount of traffic because the smartphone does not generally exist in the home during work hours on weekdays, whereas, in the case of a refrigerator or a washing machine, which is a fixed user terminal 300, even if it always induces traffic in a fixed location, the induced amount of traffic itself may appear very small. Accordingly, by collecting the induced amount of traffic of the multiple user terminals 300 for each time period, optimized communication may be provided dynamically according to time periods.

Meanwhile, the induced amount of traffic of the multiple user terminals 300 may be processed in the form of a traffic ratio value based on the user terminal 300 having the largest induced amount of traffic for each time period. That is, a traffic ratio value of 1 may be allocated to the user terminal 300 having the largest induced amount of traffic for each time period, and the traffic ratio value of other user terminals 300 may be calculated to have a value of 1 or less in proportion to the induced amount of traffic.

The multi-terminal analyzing unit 120 may configure a tuple for each user terminal 300 by collecting attribute information of each of the aforementioned multiple user terminals 300. For example, referring to Table 1 below, in the case of the user terminal 300 that may only use the 2.4 GHz band, is mobile, and induces traffic of 0.3 of the maximum traffic standard in a specific time period, a tuple may be configured with [A, M, 0.3]. However, the present disclosure is not limited thereto.

TABLE 1

| | | Induced amount of |
|---|---|---|
| Accessible band | Movable | traffic |
| A (2.4 GHz) | M (mobile) | Ratio based on |
| B (5 GHz) | F (fixed) | maximum traffic |
| C (available for both 2.4 and 5 GHz) | — | in band |

The score calculating unit 130 may calculate a score of each of channels for determining an optimal channel based on the attribute information of each of the multiple user terminals 300 collected by the multi-terminal analysis unit 120.

First, as described above, since the induced amount of traffic of each of the multiple user terminals 300 may be different for each time period, the score calculating unit 130 may set a reference time period for calculating a score.

After setting the reference time period, the score calculating unit 130 may first remove an unavailable channel in the reference time period in advance during a score calculation process. Here, the unavailable channel may be a channel in which an estimated SINR value is 0 dB or less due to a very high interference component, or a channel expected to fall short of a preset SINR threshold value by a user.

After the unavailable channel is determined, the score calculating unit 130 may calculate a score for each of the other channels except for the unavailable channel for each band. A score for each channel may be calculated using, for example, Equation 1 below. In Equation 1, A is a band, c is a channel, d is an arbitrary user terminal 300 using the corresponding band, and T_{d} may refer to a traffic ratio value of each of multiple user terminals 300:

$${Score}_{A , c} = [ {\sum }_{d = 1}^{n} ( {SINR}_{c} \times {T}_{d} ) ] \div [ {\sum }_{d = 1}^{n} {T}_{d} ] \qquad ( Equation 1 )$$

That is, according to Equation 1, a channel score for each terminal may be calculated by multiplying the obtained SINR value for each terminal by the traffic ratio for each terminal, and a final channel score may be calculated by dividing the sum of the channel scores of the respective terminals by the sum of the traffic ratios of the respective terminals. Table 2 below shows an example of calculating the score of a specific channel based on the above contents and Equation 1:

TABLE 2

| | SINR according to location and channel | | | | |
|---|---|---|---|---|---|
| | 10 | 15 | 20 | 25 | 30 |
| Traffic ratio | 0.4 | 0.2 | 1 | 0.8 | 0.1 |
| Channel score for each | 4 | 3 | 20 | 20 | 3 |
| terminal | | | | | |

| | |
|---|---|
| Final channel score | 50/(0.4 + 0.2 + 1 + 0.8 + 0.1) = 20 |

As shown in Table 2, the score that may be secured for each channel may be determined by the SINR and the traffic, and in particular, in the case of the mobile user terminal 300, the SINR value may vary depending on the location as described above. That is, the optimal communication providing method according to the present disclosure may dynamically determines an optimal channel by comprehensively considering the attributes and real-time locations of multiple user terminals 300 accessible to the AP 200, and ultimately provide optimal communication in real time to the user terminals 300.

Meanwhile, in an exemplary embodiment, the multiple user terminals 300 accessible to the AP 200 may include the user terminal 300 which is accessible to both of two or more bands (e.g., 2.4 GHz and 5 GHz), that is, the band-changeable user terminal 300.

As such, the channel score may be calculated to be different depending on which band the band-changeable user terminal 300 uses.

When the band-changeable user terminal 300 has a preferred band according to characteristics of the terminal, an accessible band of the band-changeable user terminal 300 may be determined as the corresponding band.

For example, in the case of the user terminal 300, which is a smart phone, both 2.4 GHz and 5 GHz bands may be used, but the 5 GHz band may be preferred because large-capacity content is often used. In this case, the accessible band of the band-changeable user terminal 300 may be determined as B when referring to Table 1. Meanwhile, in the case of the user terminal 300, which is a laptop computer for work, the 2.4 GHz band may be preferred because stability according to movement may be more important than large-capacity content. In this case, the accessible band of the band-changeable user terminal 300 may be determined as A when referring to Table 1.

Alternatively, the accessible band of the band-changeable user terminal 300 may be determined as C when referring to Table 1. In this case, the score calculating unit 130 may first calculate channel scores for the user terminals 300 whose bands are determined by the method described above, and then calculate the final channel score by substituting the information of the band-changeable user terminal 300 for an arbitrary number of channels having high scores for each band.

Tables 3 to 6 below show different examples for calculating the final channel score when the band-changeable user terminal 300 exists among multiple user terminals 300 accessible to the AP 200. In Tables 4 and 6, the values in six column correspond to attribute information values of the band-changeable user terminal 300.

Specifically, Table 3 shows the results of calculating the channel score by first considering only the user terminals 300 whose band is determined for channel #1 of band A, and Table 4 shows the results of calculating the final channel score of the channel #1 of band A by reflecting the band-changeable user terminal 300 on the result of Table 3.

Table 5 shows the results of calculating the channel score by first considering only the user terminals 300 whose bands are determined for channel #2 of band A, and Table 6 shows the results of calculating the final channel score of the channel #2 of band A by reflecting the band-changeable user terminal 300 on the result of Table 5.

TABLE 3

| | SINR | | | | |
|---|---|---|---|---|---|
| | 10 | 15 | 20 | 25 | 30 |
| Induced amount of traffic | 40 | 20 | 100 | 80 | 10 |
| Traffic ratio | 0.4 | 0.2 | 1 | 0.8 | 0.1 |
| Channel score for each terminal | 4 | 3 | 20 | 20 | 3 |

| | |
|---|---|
| Final channel score | 20 |

TABLE 4

| | SINR | | | | | |
|---|---|---|---|---|---|---|
| | 10 | 15 | 20 | 25 | 30 | 23 |
| Induced amount of traffic | 40 | 20 | 100 | 80 | 10 | 120 |
| Traffic ratio | 0.33 | 0.17 | 0.83 | 0.67 | 0.08 | 1 |
| Channel score for each | 3.33 | 2.5 | 16.67 | 16.67 | 2.5 | 23 |
| terminal | | | | | | |

| | |
|---|---|
| Final channel score | 20.97297297 |

TABLE 5

| | SINR | | | | |
|---|---|---|---|---|---|
| | 20 | 18 | 20 | 23 | 20 |
| Induced amount of traffic | 40 | 20 | 100 | 80 | 10 |
| Traffic ratio | 0.4 | 0.2 | 1 | 0.8 | 0.1 |
| Channel score for each terminal | 8 | 3.6 | 20 | 18.4 | 2 |

| | |
|---|---|
| Final channel score | 20.8 |

TABLE 6

| SINR | 20 | 18 | 20 | 23 | 20 | 15 |
|---|---|---|---|---|---|---|
| Induced amount | 40 | 20 | 100 | 80 | 10 | 120 |
| of traffic | | | | | | |
| Traffic ratio | 0.333 | 0.167 | 0.833 | 0.667 | 0.083 | 1 |
| Channel score for | 6.667 | 3 | 16.67 | 15.33 | 1.667 | 15 |
| each terminal | | | | | | |

| | |
|---|---|
| Final channel score | 17.88135593 |

Referring to Tables 3 to 6, it can be seen that, when considering only the user terminals 300 whose bands are determined, the score of channel #2 is calculated to be the highest in band A, but when the information of the band-changeable user terminal 300 is reflected on the assumption that the band-changeable user terminal 300 will use band A, the score of channel #1 is calculated to be the highest.

The optimal communication determining unit 140 may determine the channel having the highest score for each band based on the score for each channel within the band calculated by the score calculating unit 130, and provide the same through the AP 200.

Meanwhile, in an exemplary embodiment in which multiple user terminals 300 include the band-changeable user terminal 300, when the band-changeable user terminal 300 uses the channel having the highest score for each band, the optimal communication determining unit 140 may allow the band-changeable user terminal 300 to use the band in which an average channel score is calculated to be the highest in consideration of an average channel score for the entire band, and may simultaneously determine the channel having the highest score in the corresponding band and provide the same through the AP 200.

In this regard, Tables 7 to 10 compared to Tables 3 to 6 show examples of calculating channel scores for channels within band B. Specifically, Table 7 shows the results of calculating the channel score by first considering only the user terminals 300 whose band is determined for channel #1 of band B, and Table 8 shows the results of calculating the final channel score of the channel #1 of the band B by reflecting the band-changeable user terminal 300 on the result of Table 7.

And Table 9 shows the results of calculating the channel score by first considering only the user terminals 300 whose bands are determined for channel #2 of the band B, and Table 10 shows the results of calculating the final channel score of the channel #2 of the band B by reflecting the band-changeable user terminal 300 on the result of Table 9:

TABLE 7

| | SINR | | | | |
|---|---|---|---|---|---|
| | 30 | 20 | 15 | 15 | 20 |
| Induced amount of traffic | 30 | 35 | 40 | 50 | 20 |
| Traffic ratio | 0.6 | 0.7 | 0.8 | 1 | 0.4 |
| Channel score for each terminal | 18 | 14 | 12 | 15 | 8 |

| | |
|---|---|
| Final channel score | 19.14285714 |

TABLE 8

| SINR | 30 | 20 | 15 | 15 | 20 | 20 |
|---|---|---|---|---|---|---|
| Induced amount | 30 | 35 | 40 | 50 | 20 | 120 |
| of traffic | | | | | | |
| Traffic ratio | 0.25 | 0.292 | 0.333 | 0.417 | 0.167 | 1 |
| Channel score for each | 7.5 | 5.833 | 5 | 6.25 | 3.333 | 20 |
| terminal | | | | | | |

| | |
|---|---|
| Final channel score | 19.49152542 |

TABLE 9

| | SINR | | | | |
|---|---|---|---|---|---|
| | 10 | 15 | 20 | 25 | 30 |
| Induced amount of traffic | 30 | 35 | 40 | 50 | 20 |
| Traffic ratio | 0.6 | 0.7 | 0.8 | 1 | 0.4 |
| Channel score for each terminal | 6 | 10.5 | 16 | 25 | 12 |

| | |
|---|---|
| Final channel score | 19.85714286 |

TABLE 10

| SINR | 10 | 15 | 20 | 25 | 30 | 15 |
|---|---|---|---|---|---|---|
| Induced amount of traffic | 30 | 35 | 40 | 50 | 20 | 120 |
| Traffic ratio | 0.25 | 0.292 | 0.333 | 0.417 | 0.167 | 1 |
| Channel score for each | 2.5 | 4.375 | 6.667 | 10.42 | 5 | 15 |
| terminal | | | | | | |

| | |
|---|---|
| Final channel score | 17.88135593 |

Referring to Tables 7 to 10, it can be seen that, when considering only the user terminals 300 whose bands are determined, the score of channel #2 is calculated to be the highest in band B but when the information of the band-changeable user terminal 300 is reflected on the assumption that the band-changeable user terminal 300 will use band B, the score of channel #1 is calculated to be the highest.

Considering Tables 3 to 6 compared with Tables 7 to 10, when it is assumed that the band-changeable user terminal 300 uses band A and changes only the optimal channel of band A to channel #1 and provides the same, an average score of the channels provided in band A and band B is calculated as 20.415, which is an average value of 20.973 and 19.857.

Conversely, assuming that the band-changeable user terminal 300 uses band B and changes only the optimal channel of band B to channel #1 and provides the same, an average score of the channels provided in band A and band B is calculated as 20.146, which is an average value of 20.8 and 19.492.

In summary, when the band-changeable user terminal 300 uses the optimal channel of band A, the overall average score is the highest at 20.415, which is the highest, and thus, the optimal communication providing apparatus 100 according to the present disclosure may allow the band-changeable user terminal 300 to use the optimal channel of band A, determines the channel #1 having the highest finally calculated score by reflecting the band-changeable user terminal 300, and provide the same.

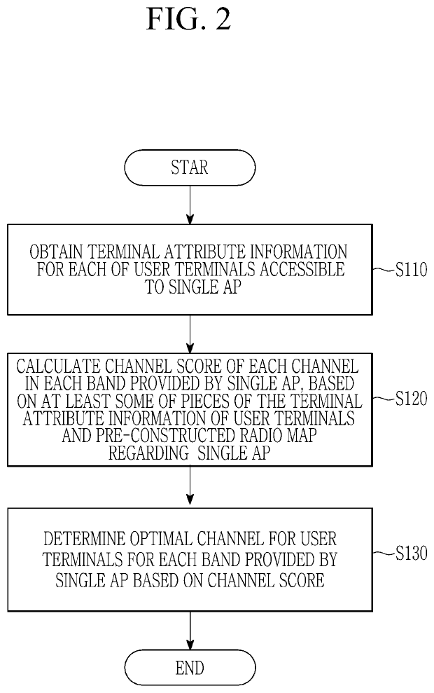

FIG. 2 is a flowchart illustrating an optimal communication providing method according to some exemplary embodiments of the present disclosure.

Referring to FIG. 2, first, the optimal communication providing apparatus 100 according to the present disclosure may obtain terminal attribute information for each of a plurality of user terminals accessible to a single AP (S110).

Next, the optimal communication providing apparatus 100 according to the present disclosure may calculate a channel score of each channel in each band provided by the single AP, based on at least some of pieces of the terminal attribute information of the plurality of user terminals and a pre-constructed radio map regarding the single AP (S120).

Next, the optimal communication providing apparatus 100 according to the present disclosure may determine an optimal channel for the plurality of user terminals for each band of the single AP based on the channel score (S130).

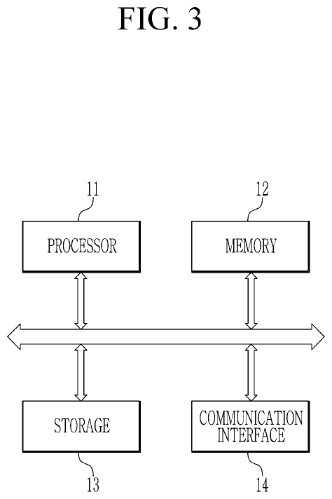

FIG. 3 is a block diagram illustrating a computing device for providing an optimal communication providing method according to some exemplary embodiments of the present disclosure.

Here, a computing device 10 providing an optimal communication providing method may be the optimal communication providing apparatus 100 described above or may be at least one AP 200 and/or a plurality of user terminals 300 communicatively connected to the optimal communication providing apparatus 100 to provide optimal communication. However, the present disclosure is not limited thereto.

Referring to FIG. 3, the computing device 10 according to the present disclosure may include one or more processors 11, a memory 12 loading a program executed by the processors 11, a storage 13 storing a program and various data, and a communication interface 14. However, the components described above are not essential to implement the computing device 10 according to the present disclosure, and the computing device 10 may have more or fewer components than the components listed above. For example, the computing device 10 may further include an output unit and/or an input unit (not shown), or the storage 13 may be omitted.

The program may include instructions that, when loaded into memory 12, cause the processor 11 to perform methods/operations according to various exemplary embodiments of the present disclosure. That is, the processor 11 may perform methods/operations according to various exemplary embodiments of the present disclosure by executing the instructions. The program includes a series of computer-readable instructions grouped together on a functional basis and is executed by a processor.

The processor 11 controls the overall operation of each component of the computing device 10. The processor 11 may include at least one of a central processing unit (CPU), a micro processor unit (MPU), a micro controller unit (MCU), a graphic processing unit (GPU), or any type of processors well known in the art of the present disclosure. Also, the processor 11 may perform an operation for at least one application or program for executing a method/operation according to various exemplary embodiments of the present disclosure.

The memory 12 stores various data, commands and/or information. The memory 12 may load one or more programs from the storage 13 to execute methods/operations according to various exemplary embodiments of the present disclosure. The memory 12 may be implemented as a volatile memory, such as RAM, but the technical scope of the present disclosure is not limited thereto.

The storage 13 may store programs non-temporarily. The storage 13 may include a non-volatile memory, such as read only memory (ROM), erasable programmable ROM (EPROM), electrically erasable programmable ROM (EEPROM), flash memory, or the like, a hard disk, a removable disk, or any type of computer-readable recording medium well known in the art. The communication interface 14 may be a wired/wireless communication module.

The exemplary embodiments of the present disclosure may not necessarily be implemented only through the foregoing devices and methods but may also be implemented through a program for realizing functions corresponding to the configurations of the exemplary embodiments of the present disclosure, a recording medium including the program, or the like.

The exemplary embodiments of the present disclosure have been described in detail, but the scope of the present disclosure is not limited thereto and various variants and modifications by a person skilled in the art using a basic concept of the present disclosure defined in claims also belong to the scope of the present disclosure.

What is claimed is:

1. An optimal communication providing method performed by a computing device, the method comprising:
obtaining terminal attribute information for each of a plurality of user terminals accessible to a single AP;
calculating a channel score for each channel within each band provided by the single AP, based on a pre-constructed radio map for the single AP and at least some of pieces of the terminal attribute information of the plurality of user terminals; and
determining an optimal channel for the plurality of user terminals for each band provided by the single AP, based on the channel score.

2. The method of claim 1, wherein the terminal property information includes
at least some of an accessible band of each of the plurality of user terminals, whether each of the plurality of user terminals is movable, and an induced amount of traffic.

3. The method of claim 2, wherein the induced amount of traffic is obtained in the form of a ratio based on a user terminal with the largest induced amount of traffic for each preset time period.

4. The method of claim 2, wherein the calculating of the channel score includes:
obtaining, for each of the user terminals whose accessible bands correspond to each other, a SINR value for a first channel within the corresponding accessible band, based on the radio map;
calculating a channel score of each user terminal for the first channel based on at least some of the SINR value of each of the user terminals whose accessible bands correspond to each other and the induced amount of traffic; and
calculating the channel score of the first channel by integrating the channel scores of the respective user terminals.

5. The method of claim 4, wherein the SINR value is a value dependent on a real-time location of each of the user terminals.

6. The method of claim 4, wherein the calculating of the channel score further includes
pre-filtering channels having an SINR value less than a predetermined threshold, among channels within the accessible band, so that the channel score is not calculated.

7. The method of claim 1, wherein the determining of the optimal channel includes
determining a channel having a highest channel score, among channels in the band, as the optimal channel for each band provided by the single AP.

8. The method of claim 1, wherein the plurality of user terminals include
at least one band-fixed terminals for which a single access band is determined, and at least one band-changeable terminal for which an access band is changeable.

9. The method of claim 8, wherein the determining of the optimal channel includes:
calculating a primary channel score for each of the channels in the corresponding access band for the band-fixed terminals, among the user terminals whose access bands correspond to each other;
calculating the channel score for each of the channels within the corresponding access band by reflecting the terminal attribute information on the band changeable terminals on the calculated primary channel score; and
determining a band and the optimal channel to be accessed by the band-changeable terminal based on the calculated channel score.

10. The method of claim 1, wherein the radio map is pre-constructed based on propagation information including reception sensitivity level information for each location of the single AP and interference information for each channel in the band for the single AP.

11. An optimal communication providing method performed by a computing device, the method comprising:
obtaining terminal attribute information for each of a plurality of user terminals accessible to a single AP;
calculating a primary channel score for each of channels within an access band, based on the terminal attribute information for at least one band-fixed terminal for which a single access band is determined, among a plurality of user terminals; and
determining an optimal channel for the plurality of user terminals for each band provided by the single AP, based on a channel score calculated by reflecting the terminal attribute information on band-changeable terminals for which an access band is changeable, among the plurality of user terminals, on the primary channel score.

12. The method of claim 11, wherein the terminal attribute information includes
at least some of an accessible band of each of the plurality of user terminals, whether each of the plurality of user terminals is movable, and an induced amount of traffic.

13. The method of claim 12, wherein the induced amount of traffic is obtained in the form of a ratio based on a user terminal with the largest induced amount of traffic for each preset time period.

14. The method of claim 12, wherein the calculating of the primary channel score includes:
obtaining, for each of the user terminals whose accessible bands correspond to each other, a SINR value for a first channel within the corresponding access band, based on a pre-constructed radio map;
calculating a channel score of each user terminal for the first channel, based on at least some of the SINR value of each of the user terminals whose access bands correspond to each other and the induced amount of traffic, and
calculating the primary channel score of the first channel by integrating the channel scores of the respective user terminals.

15. The method of claim 14, wherein the SINR value is a value dependent on a real-time location of each of the user terminals.

16. The method of claim 14, wherein the calculating of the primary channel score further includes
pre-filtering channels having an SINR value less than a predetermined threshold, among channels within the access band, so that the primary channel score is not calculated.

17. The method of claim 11, wherein the determining of the optimal channel includes
determining, for each band provided by the single AP, a channel having a highest channel score, among channels in the band, as the optimal channel.

18. The method of claim 14, wherein the radio map is pre-constructed based on propagation information including reception sensitivity level information for each location of the single AP and interference information for each channel in the band for the single AP.

19. A computing apparatus comprising:
a memory comprising instructions; and
a processor executing the instructions to:
obtain terminal attribute information for each of a plurality of user terminals accessible to a single AP;
calculate a channel score for each channel within each band provided by the single AP, based on a pre-constructed radio map for the single AP and at least some of pieces of the terminal attribute information of the plurality of user terminals; and
determine an optimal channel for the plurality of user terminals for each band provided by the single AP, based on the channel score.

20. The computing apparatus of claim 19, wherein the calculating of the channel score includes:
obtaining, for each of the user terminals whose accessible bands correspond to each other, a SINR value for a first channel within the corresponding accessible band, based on the radio map;
calculating a channel score of each user terminal for the first channel based on at least some of the SINR value of each of the user terminals whose accessible bands correspond to each other and the induced amount of traffic; and
calculating the channel score of the first channel by integrating the channel scores of the respective user terminals.
